(19) United States
(12) Patent Application Publication
(10) Pub. No.: US 2018/0356862 A1
(43) Pub. Date: Dec. 13, 2018

(54) HOUSING STRUCTURE AND MANUFACTURING METHOD THEREOF

(71) Applicant: Acer Incorporated, New Taipei City (TW)

(72) Inventors: Chi-Hung Lai, New Taipei City (TW); Cheng-Nan Ling, New Taipei City (TW); Kai-Teng Cheng, New Taipei City (TW); Pin-Chueh Lin, New Taipei City (TW); Wu-Chen Lee, New Taipei City (TW); Yung-Hui Hou, New Taipei City (TW)

(73) Assignee: Acer Incorporated, New Taipei City (TW)

(21) Appl. No.: 16/003,063

(22) Filed: Jun. 7, 2018

(30) Foreign Application Priority Data
Jun. 9, 2017 (TW) 106119232

(51) Int. Cl. G06F 1/16; B29C 43/02; B29C 45/14

(52) U.S. Cl. CPC G06F 1/1656; B29L 2031/712; B29C 45/14467; B29C 43/02

(57) ABSTRACT

A housing structure including a first part, a second part, and a film is provided. The second part is combined to the first part by injection molding, and a seam exists between the first part and the second part. The film is attached onto the first part and the second part to shield the seam. A manufacturing method of the housing structure is also provided.

### CROSS-REFERENCE TO RELATED APPLICATION

This application claims the priority benefit of Taiwan application serial no. 106119232, filed on Jun. 9, 2017. The entirety of the above-mentioned patent application is hereby incorporated by reference herein and made a part of this specification.

### BACKGROUND

### Technical Field

The disclosure relates to a housing structure and a manufacturing method thereof.

### Description of Related Art

As technology advances, housings of existing electronic apparatuses such as notebook computers become diversified. A housing may be made of any material that can be thought of. Accordingly, not only desired structural strength and specific functions can be provided, but also the overall appearance of the electronic apparatus can be enhanced. Moreover, a trend toward being lighter, slimmer and smaller is satisfied.

Nevertheless, the desired structural functions and appearance properties cannot be achieved by a single material. Hence, current housings are mostly formed by combining two or more materials. However, due to differences in the combining process and material characteristics, a gap or a seam may be left visible on the exterior of the housing. Generally, automotive painting related techniques are used to deal with such a seam. That is, a body filler is first applied to the seam, following by grinding, and painting is then performed layer by layer on the surface. However, the above-mentioned surface treatment has numerous and complicated processes, and is therefore unlikely to improve a yield or reduce costs.

### SUMMARY

The disclosure provides a housing structure and a manufacturing method thereof, in which the appearance of a housing can be enhanced by simple structure and process.

The housing structure of the disclosure includes a first part, a second part and a film. The second part is combined to the first part by injection molding, and a seam exists between the first part and the second part. The film is attached onto the first part and the second part and shields the seam.

The manufacturing method of the housing structure includes the following steps: A film is attached onto a first part. A second part is combined to the first part by injection molding, so that the film is attached onto the second part, and that the film covers a seam formed when the first part and the second part are combined together.

Based on the above, by attaching the film onto one part and then injection molding another part, the seam between the parts can be covered by the film. Therefore, the housing structure can be manufactured by simple members and processes. By using the film for covering purposes, the housing structure can be smoothly made by combining parts of various materials without a worry that the seam between the parts may be exposed to the outside. Accordingly, the housing structure can be constituted in more diverse manners.

To make the above features and advantages of the invention more comprehensible, embodiments accompanied with drawings are described in detail as follows.

### BRIEF DESCRIPTION OF THE DRAWINGS

FIG. 1 is a schematic view of an electronic apparatus according to an embodiment of the disclosure.

FIG. 2 is a schematic view of a housing structure in FIG. 1.

FIG. 3 illustrates a flowchart of a manufacturing process of the housing structure.

FIG. 4 to FIG. 6 respectively illustrate schematic views of parts of the process in FIG. 3.

### DETAILED DESCRIPTION OF DISCLOSED EMBODIMENTS

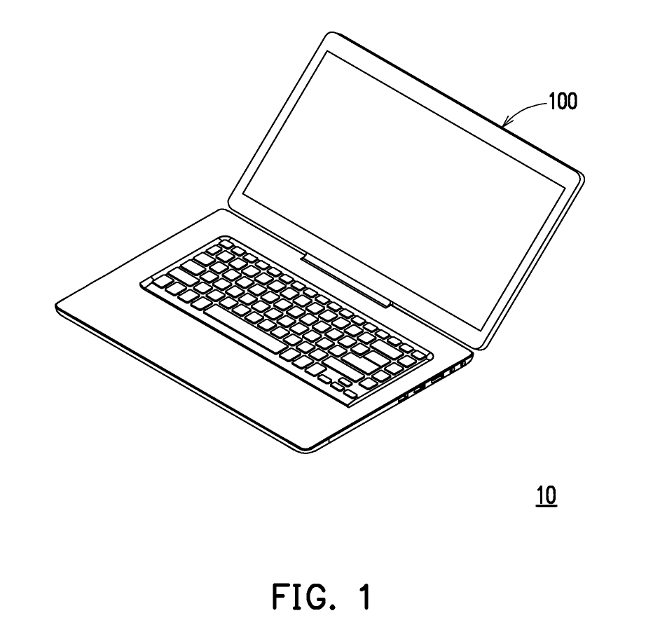

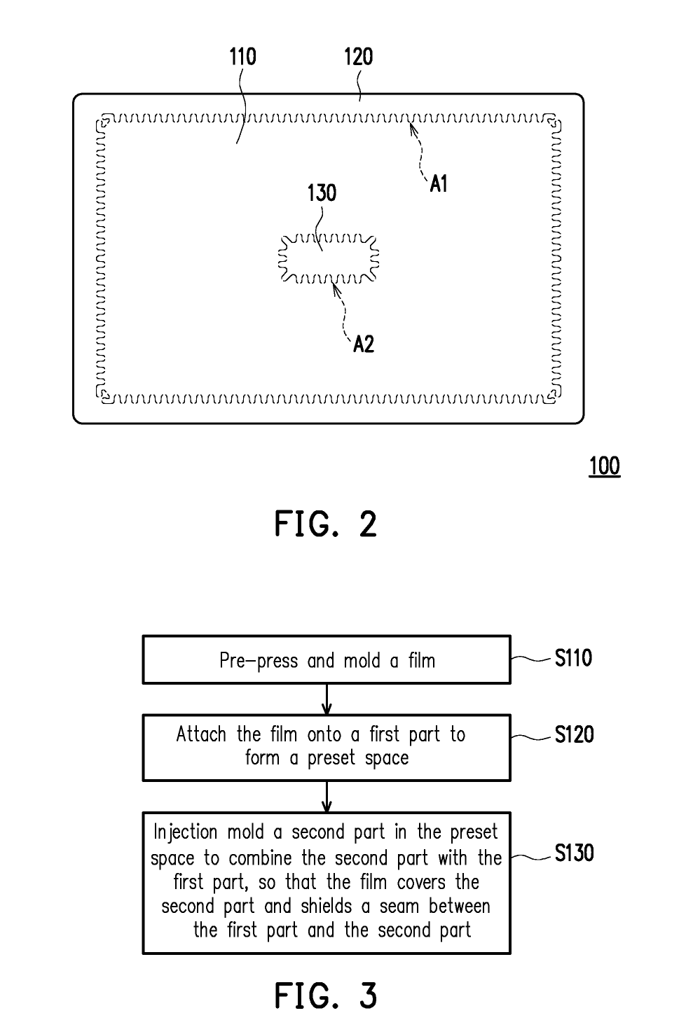

FIG. 1 is a schematic view of an electronic apparatus according to an embodiment of the disclosure. FIG. 2 is a schematic view of a housing structure in FIG. 1. Referring to FIG. 1 and FIG. 2 together, in the present embodiment, an electronic apparatus 10 is, for example, a notebook computer, and a housing structure 100 is, for example, a back cover of a display of the notebook computer. However, the scope of application of the housing structure 100 of the disclosure is not thereby limited.

Referring to FIG. 2, since the housing structure 100 is formed by combining various materials with each other, seams between the materials or parts can be clearly identified. For example, in the present embodiment, to retain structural strength of the housing structure 100 without affecting radio waves of an antenna, the housing structure 100 mainly includes a first part 110, a second part 120 and a third part 130, wherein a material of the first part 110 has high rigidity, and a material of the second part 120 and the third part 130 is, for example, plastic. By combining the second part 120 and the third part 130 to the first part 110 by injection molding techniques, a main portion of the housing structure 100 is completed.

Herein, the first part 110 having a highly rigid structure has an elastic modulus greater than or equal to 45 GPa. For example, the first part 110 may be formed of a honeycomb carbon fiber having an elastic modulus of 100.3 GPa, or an ultralight carbon fiber having an elastic modulus of 68.2 GPa, or a magnesium-aluminum alloy having an elastic modulus of 45 GPa, or an aluminum material having an elastic modulus of 69.3 Pa, or a magnesium-lithium alloy having an elastic modulus of 45 Pa. The materials exemplified above enable the housing structure 100 to exhibit a light weight, high rigidity and good heat dissipation in terms of structural functions, and the first part 110 fauns the main portion of the housing structure 100. Next, the second part 120 and the third part 130 combined to the first part 110 are produced from the remaining portion of the housing structure 100 by plastic injection molding.

However, as mentioned above, a seam may be formed between the parts due to differences between materials and manufacturing processes. In the present embodiment, the seams A1 and A2 have a dovetail groove structure, which is conducive to strengthening bonding between the parts. Of course, in other embodiments not illustrated, the parts may butt each other with a rough surface or an undulating surface, so as to effectively increase the structural strength after bonding of the parts. Details thereof are not described herein.

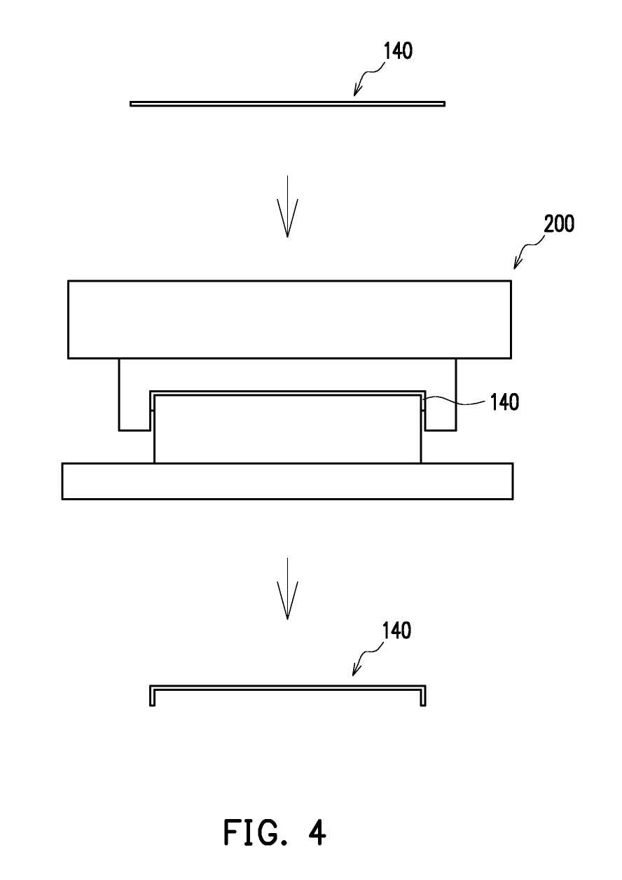

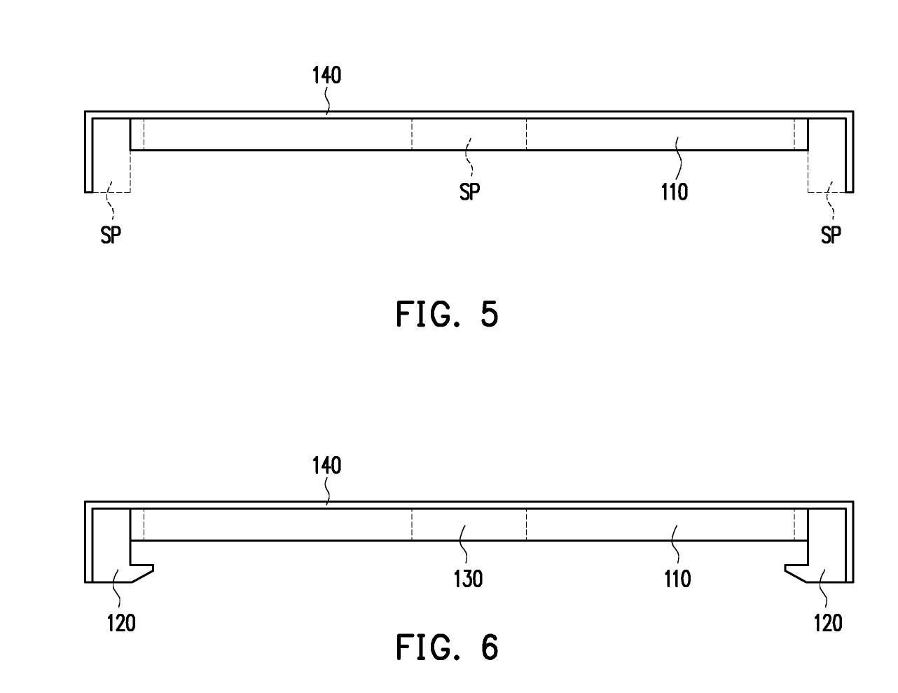

FIG. 3 illustrates a flowchart of a manufacturing process of the housing structure, in which the aforesaid seam can be prevented from affecting the appearance of the housing structure. FIG. 4 to FIG. 6 respectively illustrate schematic views of parts of the process in FIG. 3. Please refer to FIG. 3 together with FIG. 4 to FIG. 6.

In step S110, as shown in FIG. 4, a film 140 is pre-pressed and molded in advance, and the film 140 is changed from a two-dimensional state into a three-dimensional state by compression molding by a mold 200, so that a preset space SP is present between the film 140 and the first part 110 after the film 140 is attached onto the first part 110 in step S120. As shown in FIG. 5, an area of the film 140 is larger than an area of the first part 110. Thus, the aforesaid preset space SP is formed between a side edge of the film 140 and a side edge of the first part 110, and it will be clear by referring to FIG. 2 together that the preset space SP is also reserved in the center of the first part 110 for molding the third part 130. Herein, after the film 140 is pre-pressed and molded, it means that an external outline of the housing structure 100 has been formed. That is, the film 140 defines a range of space of the second part 120 and/or the third part 130 by pre-pressing and molding. Meanwhile, after the film 140 is pre-pressed and molded, a rounded(curved) corner having a radius approximately greater than a thickness of the film 140 is formed at the side edge of the film 140. For example, a rounded corner having a radius of 0.15 mm to 0.2 mm is formed.

Next, in step S130, the second part 120 and the third part 130 are molded in the aforesaid preset space SP by injection molding (e.g., in-mold injection). Thus, after molding, the film 140 is combined with both the second part 120 and the third part 130. In other words, the film 140 can be smoothly attached onto the second part 120 and the third part 130. More important, the seam A1 between the first part 110 and the second part 120 and the seam A2 between the first part 110 and the third part 130 can be shielded by the film 140. Herein, the film 140 is made of an opaque material having a thickness greater than 0.15 mm, and therefore achieves the effect of shielding the seams A1 and A2.

On the other hand, the film 140 of the present embodiment may also be patterned or colored in advance, so that after the first part 110, the second part 120 and the third part 130 are combined together, a surface pattern of the housing structure 100 can be realized by the film 140. Thus, by providing the patterned film 140, the aforesaid painting related process can be effectively replaced.

In addition, in another embodiment not illustrated, only a portion of the film that is expected to shield the seam may be designed to be opaque (e.g., by patterning or coloring). That is, when the film is provided, relative positions between the first part and the second part (or the third part) may be correspondingly designed and the rest portion that only covers a single part (instead of multiple parts) may be designed to be transparent (without the need to shield the seam). Accordingly, the housing structure can exhibit a sense of transparency in appearance by the transparent design of the film.

In summary, in the above embodiment of the disclosure, by attaching the film onto the first part and then injection molding the second part and the third part, the seams between the parts can be covered by the film so that the seams can be prevented from being exposed to the outside. In this way, the housing structure can be manufactured by simple members and processes. Meanwhile, because of the covering effect of the film, the housing structure can be smoothly made by combining parts of various materials without a worry that the seam between the parts may be exposed to the outside. Accordingly, the housing structure can be constituted in more diverse manners.

In terms of the manufacturing process of the housing structure, the film is pre-pressed and molded in advance, so that the preset space can be formed between the film and the first part after the film is attached onto the first part. The preset space is the space for injection molding the second part and the third part. Accordingly, after the injection molding is completed, the seams between the parts fall within the range shielded by the film. Therefore, the desired appearance effects for the housing structure can be achieved by a simple process.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A housing structure, comprising:
a first part;
a second part combined to the first part by injection molding, a seam existing between the first part and the second part; and
a film attached onto the first part and the second part and shielding the seam.

2. The housing structure according to claim 1, wherein a material of the first part has high rigidity, and a material of the second part is plastic.

3. The housing structure according to claim 2, wherein an elastic modulus of the first part is greater than or equal to 45 GPa.

4. The housing structure according to claim 1, wherein the seam has a dovetail groove structure.

5. The housing structure according to claim 1, wherein a thickness of the film is greater than 0.15 mm.

6. The housing structure according to claim 1, wherein an area of the film is larger than an area of the first part.

7. A manufacturing method of a housing structure, comprising:
attaching a film onto a first part; and
combining a second part to the first part by injection molding, so that the film is attached onto the second part, and that the film shields a seam formed when the first part and the second part are combined together.

8. The manufacturing method of the housing structure according to claim 7, wherein a preset space is present between a side edge of the film and a side edge of the first part, and the second part is injection molded in the preset space to be combined to the first part.

9. The manufacturing method of the housing structure according to claim 7, further comprising:
before attaching the film onto the first part, pre-pressing and molding the film.

10. The manufacturing method of the housing structure according to claim 7, wherein an area of the film is larger than an area of the first part, so that a preset space is formed after the film is attached onto the first part, and the second part is injection molded in the preset space.

11. The manufacturing method of the housing structure according to claim 7, wherein a material of the first part has high rigidity, and a material of the second part is plastic.

12. The manufacturing method of the housing structure according to claim 7, wherein an elastic modulus of the first part is greater than or equal to 45 GPa.

13. The manufacturing method of the housing structure according to claim 7, wherein the seam has a dovetail groove structure.

14. The manufacturing method of the housing structure according to claim 7, wherein a thickness of the film is greater than 0.15 mm.
